(19) United States
(12) Patent Application Publication
(10) Pub. No.: US 2013/0235081 A1
(43) Pub. Date: Sep. 12, 2013

(54) IMAGE PROCESSING APPARATUS, IMAGE PROCESSING METHOD AND RECORDING MEDIUM

(71) Applicant: CASIO COMPUTER CO., LTD., Tokyo (JP)

(72) Inventor: Jumpei ISHIBASHI, Tokyo (JP)

(73) Assignee: CASIO COMPUTER CO., LTD., Tokyo (JP)

(21) Appl. No.: 13/786,276

(22) Filed: Mar. 5, 2013

(30) Foreign Application Priority Data
Mar. 6, 2012 (JP) 2012-048911

(51) Int. Cl. G09G 5/377

(52) U.S. Cl. CPC G09G 5/377
USPC 345/638

(57) ABSTRACT

An image processing apparatus includes: a first obtaining unit which obtains a predetermined image; a specifying unit which specifies at least two orbits on a display region of a display unit, the orbits being rendered based on a predetermined operation for an operation unit by a user; and a control unit which changes a display style of the predetermined image by taking as references shapes of the at least two orbits specified by the specifying unit, the predetermined image to be moved and displayed along the orbits and to be superimposed and displayed on a background image.

### CROSS-REFERENCE TO RELATED APPLICATIONS

This application is based upon and claims the benefit of priority from the prior Japanese Patent Application No. 2012-048911, filed on Mar. 6, 2012, the entire contents of which are incorporated herein by reference.

### BACKGROUND OF THE INVENTION

1. Field of the Invention

The present invention relates to an image processing apparatus, an image processing method and a recording medium.

2. Description of Related Art

Heretofore, an electronic instrument has been known, which receives an orbit of an arbitrary shape, and moves and displays a predetermined character along the orbit concerned on a display unit (Japanese Patent Laid-Open Publication No. 2009-199622).

However, in the patent literature described above, an image of the predetermined character or the like has only been moved and displayed along the received orbit, and it has been difficult to enhance entertainment characteristics of a moving picture to be generated.

### SUMMARY OF THE INVENTION

It is an object of the present to provide an image processing apparatus capable of enhancing the entertainment characteristics of the moving picture by changing a display style of an image on a foreground, and to provide an image processing method and a recording medium.

### BRIEF DESCRIPTION OF THE DRAWINGS

The accompanying drawings, which are incorporated in and constitute a part of the specification, illustrate presently preferred embodiments of the present invention and, together with the general description given above and the detailed description of the preferred embodiments given below, serve to explain the principles of the present invention in which:

FIG. 1 is a block diagram showing a schematic configuration of a portable terminal of one embodiment to which the present invention is applied;

FIG. 2 is a flowchart, showing an example of operations related to synthetic image generation processing by the portable terminal of FIG. 1;

FIG. 3 is a flowchart showing an example of operations related to the image synthesis processing in the synthetic image generation processing of FIG. 2;

FIG. 4 is a view schematically showing an example of a foreground image related to the synthetic image generation processing of FIG. 2;

FIGS. 5A and 5B are views schematically showing an example of a background image related to the synthetic image generation processing of FIG. 2; and

FIGS. 6A to 6C are views schematically showing an example of a synthetic moving picture related to the synthetic image generation processing of FIG. 2.

### DETAILED DESCRIPTION OF THE PREFERRED EMBODIMENT

With regard to the present invention, a description is made below of a specific style thereof by using the drawings. However, the scope of the invention is not limited to the illustrated example.

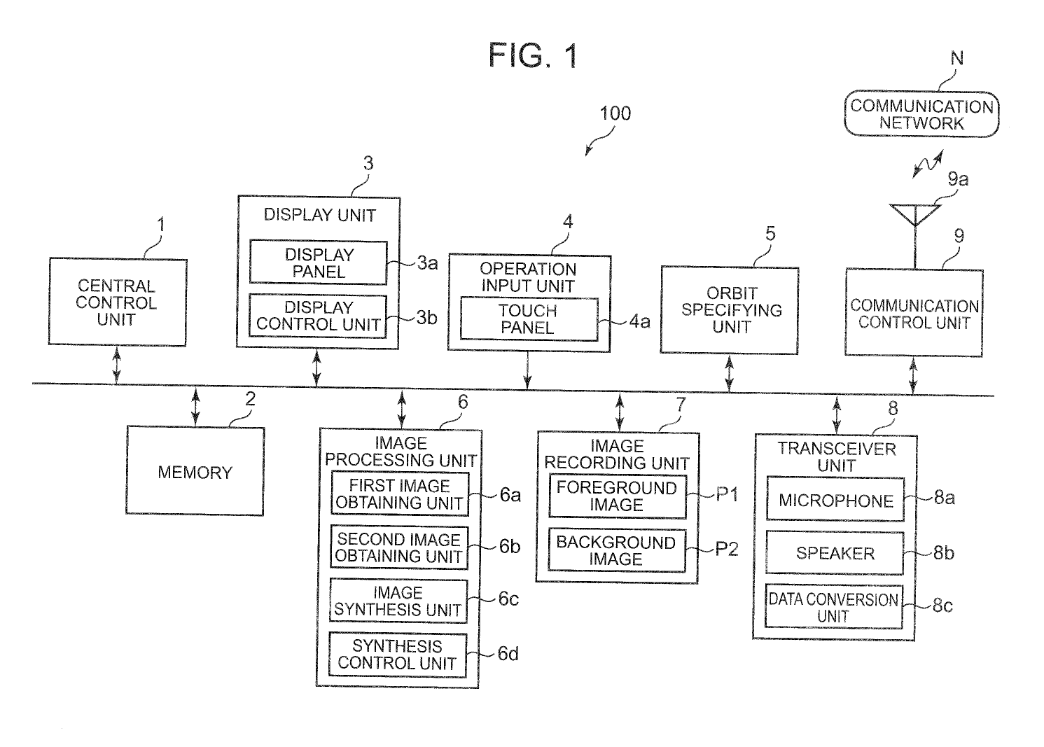

FIG. 1 is a block diagram showing a schematic configuration of a portable terminal 100 of an embodiment to which the present invention is applied.

As shown in FIG. 1, the portable terminal 100 of this embodiment includes: a central control unit 1; a memory 2; a display unit 3; an operation input unit 4; an orbit specifying unit 5; an image processing unit 6; an image recording unit 7; a transceiver unit 8; and a communication control unit 9.

Note that the portable terminal 100 is composed, for example, of an imaging device that is provided with a communication function, a mobile station for use in a mobile communication network of a cellular phone and a PHS (Personal Handy-phone System), a PDA (Personal Data Assistants), and the like.

The central control unit 1 is a unit that controls the respective units of the portable terminal 100. Specifically, though not shown, the central control unit 1 includes a CPU (Central Processing Unit), a RAM (Random Access Memory), and a ROM (Read Only Memory), and performs a variety of control operations in accordance with a variety of processing programs (not shown) for the portable terminal 100.

The memory 2 is composed, for example, of a DRAM (Dynamic Random Access Memory) and the like, and is a memory that temporarily stores data and the like, which are to be processed by the respective units such as the central control unit 1 and the image processing unit 6.

The display unit 3 includes: a display panel 3a; and a display control unit 3b.

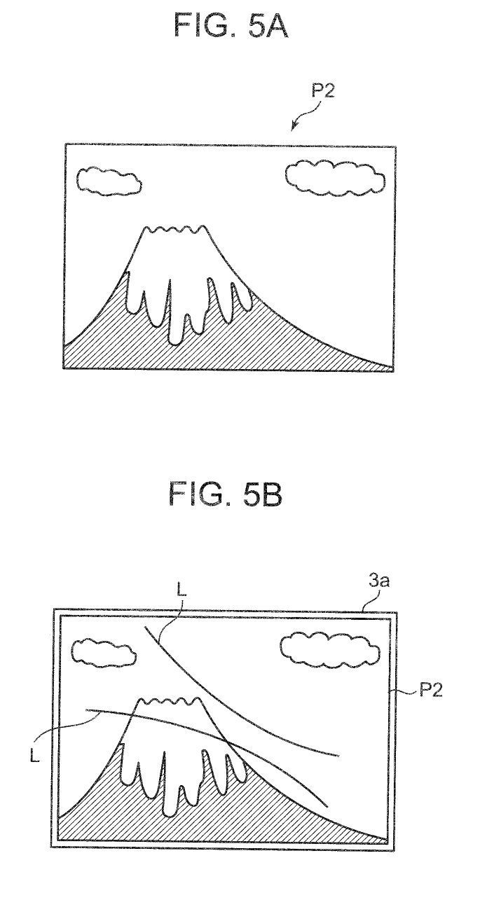

The display panel 3a displays an image (for example, a background image P2 and the like; refer to FIG. 5A and the like). Moreover, as the display panel 3a, for example, a liquid crystal display panel, an organic EL display panel and the like are mentioned; however, these are merely examples, and the display panel 3a is not limited to these.

Based on image data with a predetermined size, which is read out from the image recording unit 7 and decoded by the image processing unit 6, the display control unit 3b performs control to display a predetermined image on a display screen of the display panel 3a. Specifically, the display control unit 3b includes a VRAM (Video Random Access Memory), a VRAM controller, a digital encoder, and the like. Then, the digital video encoder reads out a brightness signal Y and color difference signals Cb and Cr, which are decoded by the image processing unit 6 and stored in the VRAM (not shown), from the VRAM through the VRAM controller at a predetermined reproduction frame rate (for example, 10 fps), and based on these data, generates a video signal and outputs the generated video signal to the display unit 3.

The operation control unit 4 is a unit that inputs a variety of instructions to a body of the portable terminal 100.

Specifically, the operation input unit 4 includes: upper, lower, left and right cursor buttons and a decision button, which are related to selection instructions for a style, a function and the like; communication-related buttons related to execution instructions for sending/receiving of a telephone call, and the like; and a variety of buttons such as numeric buttons and symbol buttons, which are related to input instructions for text (any of the above is not shown).

Then, when the variety of buttons are operated by a user, the operation input unit 4 outputs operation instructions, which correspond to the operated buttons, to the central control unit 1. The central control unit 1 allows the respective units to perform predetermined operations (for example, imaging of a subject, sending/receiving of a telephone call, transmission/reception of electronic mail, and the like) in accordance with the operation instructions outputted from the operation input unit 4 and inputted thereby.

Moreover, the operation input unit 4 includes a touch panel 4a provided integrally with the display panel 3a of the display unit 3.

The touch panel 4a detects contact positions of a finger (hand) of the user, a touch pen and the like, which directly or indirectly contact the display screen that forms a display region of the display panel 3a. That is to say, for example, the touch panel 4a is provided on the display screen or in an inside more than the display screen concerned, and detects XY coordinates of the contact positions on the display screen by a variety of methods such as a resistive film method, an ultrasonic surface elastic wave method, and an electrostatic capacitance method. Then, the touch panel 4a outputs position signals related to the XY coordinates of the contact positions.

Note that detection accuracy of the contact positions on the display screen by the touch panel 4a is changeable arbitrarily as appropriate, and for example, one pixel may be strictly set as the contact position, or a plurality of pixels within a predetermined range in which one pixel is taken as a center may be set as the contact position.

The orbit specifying unit 5 is a unit that specifies operation orbits L (refer to FIG. 5B) corresponding to predetermined rendering operations by the user.

That is to say, the orbit specifying unit 5 specifies at least two operation orbits L and L, which are rendered based on the predetermined operation for the operation input unit 4 by the user, on the display region of the display panel 3a. Specifically, upon receiving the position signals related to the XY coordinates of the contact positions detected continuously by the touch panel 4a of the operation input unit 4, the orbit specifying unit 5 specifies each of the contact positions of the touch panel 4a concerned as each of operation points on the display region of the display panel 3a. Then, the orbit specifying unit 5 connects such a plurality of the specified operation points to one another, and thereby individually specifies the operation orbits L corresponding to the respective rendering operations by the user.

Note that the rendering of the respective operation orbits L, which uses the predetermined operation for the operation input unit 4, may be performed in a state where the background image P2 is displayed on the display region of the display panel 3a. That is to say, as will be described later, a synthetic position of a foreground image P1 in the background image P2 is designated by using the operation orbits L, and accordingly, it becomes possible for the user to grasp a position where the foreground image P1 is synthesized with and displayed in the background image P2 displayed on the display region.

Moreover, the predetermined operation by the user for the operation input unit 4 related to the rendering of the respective operation orbits L may be, for example, an operation of rendering the plurality of operation orbits at substantially the same timing in such a manner of so-called multi-touch, or such an operation as rendering the respective operation orbits L at different timing while shifting a time axis.

Note that, in FIG. 5B, an example of the two operation orbits L and L is schematically shown on the display region of the display panel 3a; however, it is possible to arbitrarily change as appropriate whether or not to display the operation orbits L so as to be visually recognizable.

Moreover, shapes and number of the respective operation orbits L are merely examples, are not limited to these described above, and are arbitrarily changeable as appropriate. Here, for example, in the case where three or more of the operation orbits L are specified, a configuration may be adopted, in which it is possible for the user to select desired two operation orbits L and L based on a predetermined operation for the operation input unit 4.

The image processing unit 6 decodes such image data of a still image or a moving picture, which is related to a display target and read out from the image recording unit 7, in accordance with a predetermined encoding method (for example, a JPEG format, a motion PEG format, an MPEG format and the like) corresponding thereto, and outputs the decoded image data to the display control unit 3b. At this time, for example, the image processing unit 6 reduces the image data, which is read out from the image recording unit 7, to a predetermined size (for example, a VGA or QVGA size) based on a display resolution of the display panel 3a, and the like, and outputs the reduced image data to the display control unit 3b.

Moreover, the image processing unit 6 includes: a first image obtaining unit 6a; a second image obtaining unit 6b; an image synthesis unit 6c; and a synthesis control unit 6d.

Note that, for example, the respective units of the image processing unit 6 are composed of predetermined logic circuits; however, such a configuration concerned is merely an example, and the respective units of the image processing unit 6 are not limited to this.

The first image obtaining unit 6a obtains the foreground image P1 for use in synthetic image generation processing (described later).

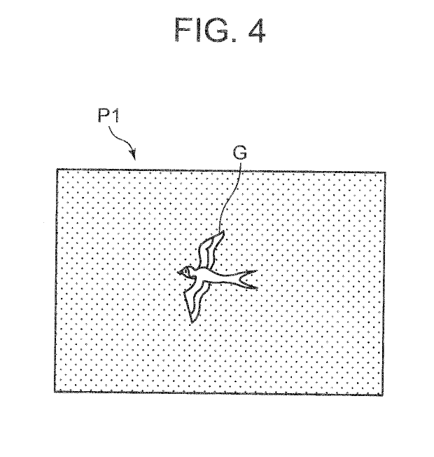

That is to say, the first image obtaining unit 6a obtains an image, which is desired by the user, as the foreground image P1. Specifically, among at least one of the foreground image P1 recorded in the image recording unit 7, the first image obtaining unit 6a obtains image data of the foreground image P1 (refer to FIG. 4), which is desired by the user and designated based on the predetermined operation for the operation input unit 4 by the user.

The second image obtaining unit 6b obtains the background image P2 for use in the synthetic image generation processing.

That is to say, the second image obtaining unit 6b obtains an image, which is desired by the user, as the background image P2 Specifically, among at least one of the background image P2 recorded in the image recording unit 7, the second image obtaining unit 6b obtains image data of the background image P2 (refer to FIG. 5A and the like), which is desired by the user and designated based on the predetermined operation for the operation input unit 4 by the user.

The image synthesis unit 6c performs image synthesis processing for synthesizing the background image P2 and the foreground image P1 with each other.

That is to say, the image synthesis unit 6c synthesizes the foreground image P1, which is obtained by the first image obtaining unit 6a, and the background image P2, which is obtained by the second image obtaining unit 6b, with each other, and generates a synthetic image. Specifically, with regard to the respective pixels of the background image P2, the image synthesis unit 6c transmits pixels of the foreground image P1, which are pixels with an alpha value of 0, through the background image P2 concerned, and with regard to pixels of the foreground image P1, which are pixels with an alpha value of 1, the image synthesis unit 6c overwrites the pixels of the background image P2 by pixel values of the pixels of the foreground image P1, which correspond thereto. Moreover, among the respective pixels of the background image P2, with regard to pixels of the foreground image P1, which are pixels in which an alpha value is 0<α<1, the image synthesis unit 6c generates an image (background image×(1−α)), from which a subject region G of the foreground image P1 is clipped out, by using a complement (1−α) of 1, thereafter calculates a value blended with a single background color in the event where the foreground image P1 is generated by using the complement (1−α) of 1 in an alpha map, subtracts the value concerned from the foreground image P1, and synthesizes an obtained resultant with the image (background image×(1−α)) from which the subject region G is clipped out.

Moreover, in the case of generating the moving picture as the synthetic image, the image synthesis unit 6c performs the above-described respective pieces of processing for each of frame images which compose the moving picture. Note that the foreground image P1 and the background image P2, which are used for the generation of the respective frame images, will be described later.

The synthesis control unit 6d controls a change of a display style of the foreground image P1 to be synthesized with the background image P2.

That is to say, by taking, as references, the at least two operation orbits L and L specified by the orbit specifying unit 5, the synthesis control unit 6d changes the display style of the foreground image P1 (predetermined image), which is moved and displayed along the operation orbits L concerned, and in addition, is superimposed and displayed on the background image P2. Moreover, in the event of controlling the image synthesis processing by the image synthesis unit 6c, and synthesizing the background image P2 and the foreground image P1 with each other by the image synthesis unit 6c, the synthesis control unit 6d changes the display style of the foreground image P1. That is to say, the synthesis control unit 6d synthesizes each of a plurality of the foreground images P1, in which a synthetic position, size, orientation and the like of the subject region G are changed at a predetermined interval (for example, a distance interval, a time interval and the like), and the background image P2 with each other by the image synthesis unit 6c, and generates a synthetic moving picture M.

Specifically, the synthesis control unit 6d changes a synthetic position of the subject region G, which is to be superimposed and displayed on the background image 2, at a predetermined pixel interval so as to move the subject region G of the foreground image P1 along the two operation orbits L and L, which are specified by the orbit specifying unit 5, along the operation orbits L concerned.

At this time, the synthesis control unit 6d may change the size of the subject region G of the foreground image P1 in response to the interval between the two operation orbits L and l at the synthetic position of the foreground image P1. The change of the size of the subject region G is performed, for example, so that a ratio in number of pixels (size) between a horizontal direction (predetermined direction) of the subject region G and a vertical direction (direction perpendicular to the predetermined direction) thereof cannot be changed. Specifically, the synthesis control unit 6d resizes an image size of the foreground image P1 (refer to FIG. 4) so that, in the case where the number of pixels in the predetermined direction (for example, the horizontal direction and the like) of the subject region G is increased and decreased in response to the interval between the two operation orbits L and L at the synthetic position of the subject region G, the number of pixels in the direction (for example, the vertical direction and the like) perpendicular to the predetermined direction of the subject region G concerned can also be increased and decreased in response to a degree of the increase/decrease of the number of pixels in the predetermined direction concerned. Here, the number of pixels in each of the horizontal direction and vertical direction of the subject region G may include the number of pixels of a frame with a predetermined shape (for example, a rectangular shape), which surrounds the subject region G concerned.

Moreover, in response to an orientation of the two operation orbits L and L, the synthesis control unit 6d may change an orientation where the subject region G of the foreground image P1 is synthesized. Specifically, the synthesis control unit 6d may change the orientation of the subject region G, for example, by setting a reference line (not shown) that passes through positions at an equal distance from the two operation orbits L and L between the respective operation orbits L concerned, and rotating the foreground image P1 about a predetermined position of the subject region G, which is taken as a center (predetermined position), in a predetermined direction so that a reference line segment (not shown), which passes through the center of the subject region G concerned, can be substantially perpendicular to the reference line concerned.

Moreover, at a predetermined pixel interval, the synthesis control unit 6d may change the synthetic position of the subject region G, which is to be superimposed and displayed on the background image P2, so as to move a display position of the subject region G of the foreground image P1 from a start point side in the event where any one operation orbit L between the two operation orbits L and L is rendered to an end point side therein. Here, the change of the synthetic position of the subject region G may be performed, for example, by taking, as a reference, a reference line (not shown) that passes through predetermined positions (for example, positions at an equal distance, and the like) between the two operation orbits L and L, or may be performed by taking at least either one of the operation orbits L as references. Moreover, in the case where lengths of the respective operation orbits L differ from each other, the change of the synthetic position of the subject region G may be performed so that ratios of the subject region G with respect to overall lengths of the respective operation orbits L can become equal to each other.

Note that the display position of the subject region G of the foreground image P1 may be moved from the endpoint side in the event where any one operation orbit L is rendered to the start point side therein.

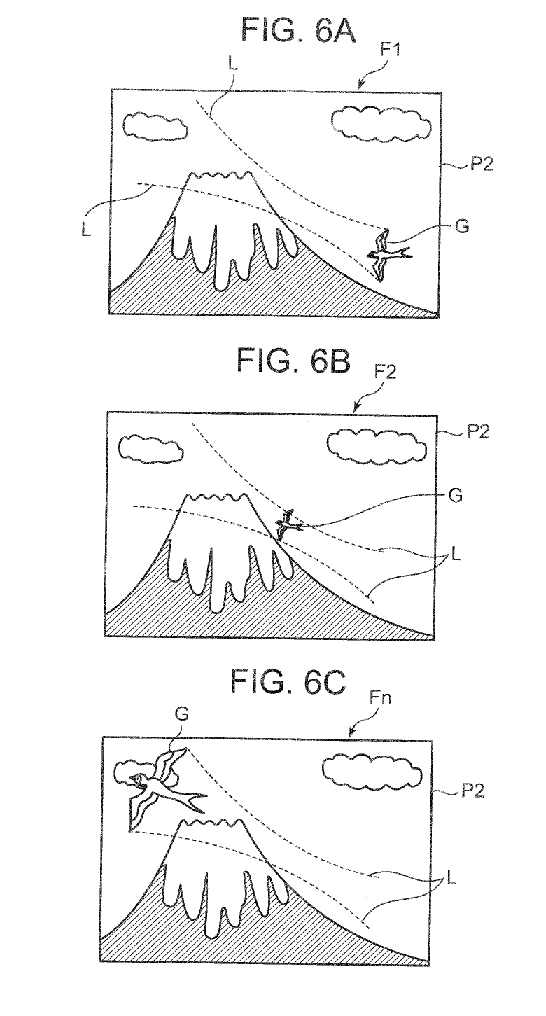

For example, in the case of moving and displaying the foreground image P1 by every predetermined number of pixels in a predetermined direction (for example, an X-axis direction and the like) along the operation orbits L, the synthesis control unit 6d sets the synthetic position, size and orientation of the subject region G of the foreground image P1 concerned so that the subject region G can be located between the two operation orbits Land L at a predetermined position on the start point side of either one operation orbit L between the two operation orbits L and L. Then, by the image synthesis unit 6c, the subject region G of the foreground image P1 is synthesized with the background image P2, and a first frame image F1 is generated (refer to FIG. 6A). Thereafter, the synthesis control unit 6d sets the synthetic position, size and orientation of the subject region G of the foreground image P1 concerned so that the subject region G can be located between the two operation orbits L and L at a position that has moved by a predetermined number of pixels to the endpoint side along the operation orbits L. Then, by the image synthesis unit 6c, the subject region G of the foreground image P1 is synthesized with the background image P2, and a second frame image F2 is generated (refer to FIG. 6B).

The synthesis control unit 6d sequentially performs the above-described processing in a similar way also for third frame images and after (not shown), and finally, sets the synthetic position, size and orientation of the subject region G of the foreground image P1 concerned so that the subject region G can be located between the two operation orbits L and L at a position on the end point side of the operation orbit L. Then, by the image synthesis unit 6c, the subject region G of the foreground image P1 is synthesized with the background image P2, and a final frame image Fn is generated (refer to FIG. 6C).

In such a way, as the synthetic images, the synthetic moving picture M composed of a plurality of frame images F. is generated.

The image recording unit 7 is composed, for example, of a non-volatile memory (flash memory) and the like. Moreover, the image recording unit 7 records image data of a variety of images (for example, the foreground image P1, the background image P2, and the like) encoded in accordance with the predetermined encoding method by an encoding unit (not shown) of the image processing unit 6.

For example, the foreground image P1 is a still image, and there is mentioned a still image of a subject-clipped image generated in subject clipping processing for extracting the subject region G (for example, a bird and the like) from a subject-present image in which a subject is present in a predetermined background (refer to FIG. 4). Moreover, the image data of the foreground image P1 is associated with an alpha map generated in the subject clipping processing.

Here, the alpha map is a map that, for each of the pixels of the foreground image P1, represents weight as an alpha value (0≦α≦1), the weight being in the event of performing alpha blending for the subject region G (refer to FIG. 4) of the foreground image P1 concerned with a predetermined background.

For example, the background image P2 is a still image, and is an image to be displayed as the background of the foreground image P1. Moreover, the image data of the background image P2 is encoded in accordance with a predetermined encoding method (for example, the JPEG format and the like).

Note that, for example, each of the foreground image P1 and the background image P2 may be a moving picture composed of a plurality of frame images. Specifically, as each of the foreground image P1 and the background image P2, for example, there are mentioned: moving picture data composed of a plurality of continuous frame images imaged at a predetermined frame rate; continuously imaged image data imaged continuously at a predetermined shutter speed.

The transceiver unit 8 performs a telephone conversation with an external user of an external instrument connected to the portable terminal 100 through a communication network N.

Specifically, the transceiver unit 8 includes: a microphone 8a; a speaker 8b; a data conversion unit 8c; and the like. Then, the transceiver unit 8 performs A/D conversion processing for user's transmitted voice, which is inputted from the microphone 8a, by the data conversion unit Sc, and outputs transmitted voice data to the central control unit 1, and in addition, under control of the central control unit 1, performs D/A conversion processing for voice data such as received voice data, which is outputted from the communication control unit 9, and is inputted to the transceiver unit 8 concerned, by the data conversion unit 8c, and outputs the processed voice data to the speaker 8b.

The communication control unit 9 performs transmission/reception for data through the communication network N and a communication antenna 9a.

That is to say, the communication antenna 9a is an antenna capable of data transmission/reception corresponding to a predetermined communication method (for example, the W-CDMA (Wideband Code Division Multiple Access) method, the CDMA 2000 method, the GSM (Global System for Mobile Communications) method and the like) which the portable terminal 100 concerned adopts in communication with a radio base station (not shown). Then, in accordance with communication protocol corresponding to the predetermined communication method, the communication control unit 9 performs the transmission/reception of the data through the communication antenna 9a with the radio base station by a communication channel set by this communication method.

That is to say, based on instruction signals to be outputted from the central control unit 1 and inputted to the communication control unit 9, for the external instrument as a communication partner, the communication control unit 9 concerned performs transmission/reception of voice during the telephone conversation with the external user of the external instrument concerned, and the transmission/reception of the electronic mail therewith.

Note that the above-described configuration of the communication control unit 9 is merely an example, and the communication control unit 9 is not limited to this, and is changeable arbitrarily as appropriate. For example, though not shown, a configuration may be adopted, which is capable of accessing the communication network N through an access point (Access Point) by mounting a wireless LAN module thereon.

The communication network N connects the portable terminal 100 thereto through the radio base station, a gateway server (not shown) and the like. Moreover, the communication network N is a communication network constructed by using a private line or an existing general public line, and a variety of line forms such as a LAN (Local Area Network) and a WAN (Wide Area Network) are applicable thereto.

Moreover, for example, the communication network N includes: a variety of communication networks such as a telephone line network, an ISDN line network, a private line, a mobile communication network, a communication satellite line, and a CATV line network; the IP network; a VoIP (Voice over Internet Protocol) gateway; an Internet service provider; and the like.

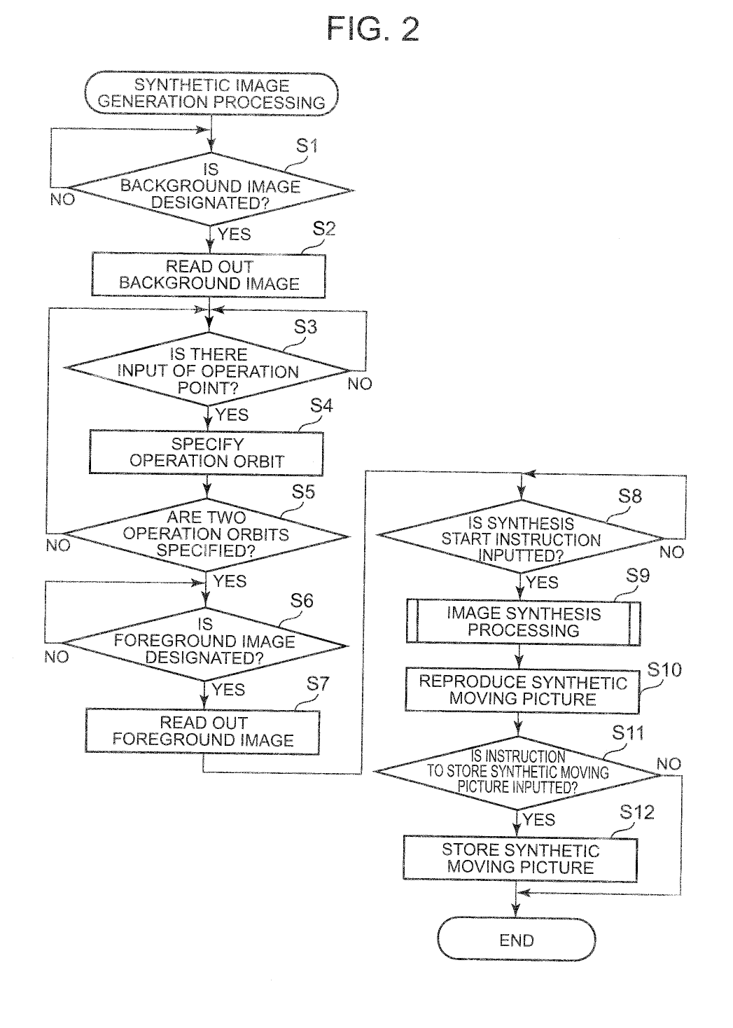

Next, with reference to FIG. 2 to FIG. 6, a description is made of the synthetic image generation processing by the portable terminal 100.

FIG. 2 is a flowchart showing an example of operations related to the synthetic image generation processing.

The synthetic image generation processing, which will be described below, is processing to be executed in the case where an image synthesis style is selected and designated from among a plurality a plurality of operation styles, which are displayed on a menu screen, based on the predetermined operation for the operation input unit 4 by the user.

### <Synthetic Image Generation Processing>

As shown in FIG. 2, first, the display control unit 3b displays a predetermined message, which instructs the designation of the background image P2, on the display screen of the display panel 3a, and based on the predetermined operation for the operation input unit 4 by the user, the central control unit 1 determines whether or not the background image P2 desired by the user is designated among at least one of the background images P2 displayed on the display panel 3a (Step S1).

Here, when it is determined that the desired background image P2 (refer to FIG. 5A and the like) is designated (Step S1; YES), then from among the at least one background image P2 recorded in the image recording unit 7, the second image obtaining unit 6b of the image processing unit 6 reads out and obtains the image data of the background image P2, which is desired by the user and is designated based on the predetermined operation for the operation input unit 4 by the user (Step S2).

Note that, when it is determined in Step S1 that the background image P2 is not designated (Step S1; NO), the central control unit 1 returns the processing to Step S1, and until it is determined that the background image P2 is designated (Step S1; YES), puts the processing on standby in a state where the predetermined message related to the designation of the background image P2 is displayed on the display screen of the display panel 3a.

Subsequently, within a predetermined period, the central control unit 1 determines whether or not there is an input instruction for the operation point on the display region of the display panel 3a by the user (Step S3). Specifically, in response to whether or not the position signals related to the XY coordinates of the contact positions, which are outputted from the touch panel 4a in such a manner that the contact of the finger (hand) of the user, the touch pen and the like with the display screen of the display panel 3a is detected by the touch panel 4a concerned, are inputted, the central control unit 1 determines whether or not there is an input of the operation point by the user.

When it is determined in Step S3 that there is no input of the operation point by the user (Step S3 NO), the central control unit 1 returns the processing to Step S3, and repeatedly executes the above-described determination processing at predetermined timing (Step S3).

Meanwhile, when it is determined in Step S3 that there is an input of the operation point by the user (Step S3: YES), the orbit specifying unit 5 specifies the operation orbits L, which correspond to the respective rendering operations by the user, from the plurality of operation points (Step S4: refer to FIG. 5B).

Subsequently, the image processing unit 6 determines whether or not the two operation orbits L and L are specified by the orbit specifying unit 5 (Step S5).

Here, when it is determined that the two operation orbits L and L are not specified by the orbit specifying unit 5 (Step S5; NO), then the central control unit 1 returns the processing to Step S3, and receives a next input instruction for the operation point on the display region of the display panel 3a.

Then, when it is determined that the two operation orbits L and L are specified by the orbit specifying unit 5 in Step S5 (Step S5; YES), the display control unit 3b displays a predetermined message, which instructs the designation of the foreground image P1, on the display screen of the display panel 3a, and based on the predetermined operation for the operation input unit 4 by the user, the central control unit 1 determines whether or not the foreground image P1 desired by the user is designated among the at least one of the foreground images P1 displayed on the display panel 3a (Step S6).

Here, when it is determined that the desired foreground image P1 (refer to FIG. 4) is designated (Step S6; YES), then from among the at least one foreground image P1 recorded in the image recording unit 7, the first image obtaining unit 6a of the image processing unit 6 reads out and obtains the image data of the foreground image P1, which is desired by the user and is designated based on the predetermined operation for the operation input unit 4 by the user (Step S7).

Note that, when it is determined in Step S6 that the foreground image P1 is not designated (Step S6; NO), the central control unit 1 returns the processing to Step S6, and until it is determined that the foreground image P1 is designated (Step S6; YES), puts the processing 3 on standby in a state where the predetermined message related to the designation of the foreground image P1 is displayed on the display screen of the display panel 3a.

Next, based on the predetermined operation for the operation input unit 4 by the user, the central control unit 1 determines whether or not a start instruction for the synthesis between the background image P2 and the foreground image P1 is inputted (Step S8).

Here, when it is determined that such a synthesis start instruction is not inputted (Step S8; NO), the central control unit 1 returns the processing to Step S8, and puts the processing on standby until it is determined that the synthesis start operation is inputted (Step S8; YES).

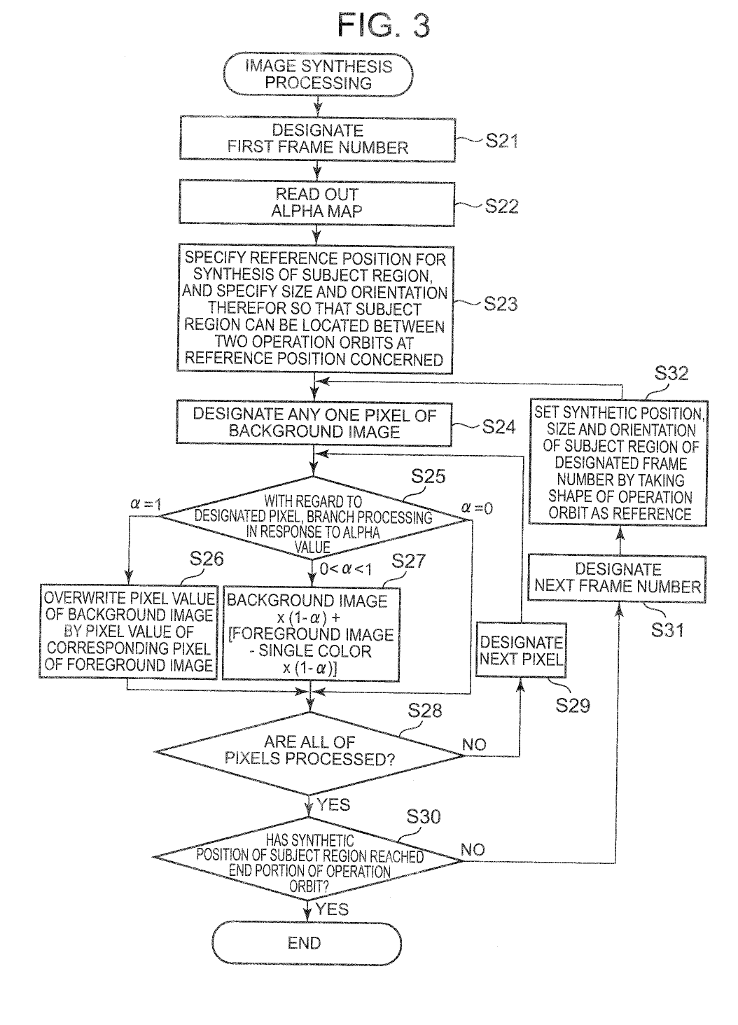

When it is determined in Step S8 that the synthesis start instruction is inputted (Step S8; YES), then under control of the synthesis control unit 6d, the image synthesis unit 6c performs the image synthesis processing (refer to FIG. 3) for synthesizing the background image P2 and subject region G of the foreground image P1 with each other (Step S9).

Here, a description is made in detail of the image synthesis processing with reference to FIG. 3. FIG. 3 is a flowchart showing an example of operations related to the image synthesis processing.

### <Image Synthesis Processing>

As shown in FIG. 3, first, the synthesis control unit 6d designates “1” as a frame number of the first frame image F1 serving as a processing target (Step S21).

Subsequently, the image synthesis unit 6c reads out the alpha map stored in association with the foreground image P1, and expands the alpha map concerned to the memory 2 (Step S22).

Next, the synthesis control unit 6d specifies a reference position, size and orientation for the synthesis of the subject region G of the foreground image P1 in the background image P2 (Step S23). Specifically, for example, by taking, as references, shapes of the two operation orbits L and L specified by the orbit specifying unit 5, the synthesis control unit 6d specifies the reference position for the synthesis so that the subject region G can individually contact one-side end portions (for example, right end portions) of the two operation orbits L and L concerned, and in addition, specifies the size and orientation of the subject region G so that the subject region G can be located between the two operation orbits L and L.

Note that, with regard to a region that goes out of a range of the alpha map by the fact that the alpha map is shifted with respect to the background image P2 in the event where the synthetic position of the subject region G is decided in Step S23, α is set equal to 0, and a region where the alpha value is not present is allowed not to be present.

Subsequently, the image synthesis unit 6c designates any one pixel (for example, a pixel on an upper left corner portion) of the background image P2 (Step S24), and with regard to the pixel concerned, branches the processing based on the alpha value of the alpha map (Step S25). Specifically, among any one pixel of the background image P2, with regard to a pixel in which an alpha value is 1 (Step S25; α=1), the image synthesis unit 6c overwrites the pixel value of the background image P2 by the pixel value of the pixel of the foreground image P1, which corresponds thereto (Step S26). With regard to a pixel in which an alpha value is 0<α<1 (Step S25; 0<α<1), the image synthesis unit 6c generates the image (background image×(1−α)) from which the subject region G is clipped out, by using the complement (1−α) of 1, thereafter calculates the value blended with the single background color in the event where the foreground image P1 is generated by using the complement (1−α) of 1 in the alpha map, subtracts the value concerned from the foreground image P1, and synthesizes the obtained resultant with the image (background image×(1−α)) from which the subject region G is clipped out (Step S27). With regard to a pixel in which an alpha value is 0, the image synthesis unit 6c (Step S25; α=0), the image synthesis unit 6c allows transmission of the background image P2 without doing anything.

Subsequently, the image synthesis unit 6c determines whether or not all of the pixels of the background image 6c are processed (Step S28).

Here, when it is determined that all of the pixels are not processed (Step S28; NO), the image synthesis unit 6c designates a next pixel as the processing target, moves the processing target to the pixel concerned (Step S29), and shifts the processing to Step S25.

The above-described processing is repeated until it is determined that all of the pixels are processed in Step S28 (Step S28; YES), the image synthesis unit 6c generates the first frame image F1 (refer to FIG. 6A) that composes the synthetic moving picture M in which the foreground image P1 and the background image P2 are synthesized with each other.

Then, when it is determined that all of the pixels are processed in Step S28 (Step S28; YES), the synthesis control unit 6d determines whether or not the synthetic position of the subject region G has reached end portions of the operation orbits L, which are on an opposite side to the reference position (Step S30).

Here, when it is determined that the synthetic position of the subject region G has not reached the end portions of the operation orbits L (Step S30; NO), then among the plurality of frame images F . . . which compose the synthetic moving picture M, the synthesis control unit 6d increases by one a frame number related to a next frame image (for example, the second frame image F2) serving as the processing target, and designates the increased frame number (Step S31). In such a way, the second frame image F2 of the synthetic moving picture M becomes the processing target of the image synthesis processing.

Next, by taking the shapes of the two operation orbits L and L as references, the synthesis control unit 6d sets a synthetic position, size, orientation and the like of the subject region G in the second frame image F2 of the synthetic moving picture M (Step S32). Specifically, the synthesis control unit 6d sets the synthetic position, size and orientation of the subject region G of the foreground image P1 concerned so that the subject region G can be located between the two operation orbits L and L at the position that has moved by the predetermined number of pixels to the endpoint side along the two operation orbits L and L. At this time, the synthesis control unit 6d corrects such a subject region portion (α=1) in the alpha map and such a portion (α=0) other than the subject region therein in response to the subject region G of the foreground image P1, in which the synthetic position, the size and the orientation are changed.

Next, the image synthesis unit 6c shifts the processing to Step S24, sequentially performs the respective pieces of processing of Steps S25 to S29, for example, from the pixel on the upper left corner portion of the background image P2, and thereby generates the second frame image F2 that composes the synthetic moving picture M in which the foreground image P1 and the background image P2 are synthesized with other. In such a way, by taking the shapes of the two operation orbits L and L as references, the second frame image F2 (refer to FIG. 6B) is generated, in which the synthetic position, size, orientation and the like of the subject region G of the foreground image P1 are changed.

Then, when it is determined that all of the pixels are subjected to the synthesis processing in Step S29 (Step S29; YES) by the fact that the generation of the second frame image F2 is completed, the synthesis control unit 6d shifts the processing to Step S30, and in a similar way to the above, determines whether or not the synthetic position of the subject region G has reached the end portions of the operation orbits L, which are on the opposite side to the reference position (Step S30).

Note that, in Step S32, in the case where the synthetic position that has moved by the predetermined number of pixels to the end point side along the two operation orbits L and L becomes a position that goes beyond the endpoints (end portions on the opposite side to the reference position of the operation orbits L, the synthetic position of the subject region G is set so that the subject region G can individually contact the endpoints of the two operation orbits L and L. In other words, in the final frame image Fn that composes the moving picture, a state is brought where the subject region G is in contact with the end portions of the operation orbits L on the opposite side to the reference position.

The above-described synthesis processing is repeated until it is determined that the synthetic position of the subject region G has reached the end portions of the operation orbits L in Step S30 (Step S30; YES), whereby the image synthesis unit 6c generates all of the frame images (refer to FIG. 6A to FIG. 6C) which compose the synthetic moving picture.

In such a way, the image synthesis processing is ended.

Next, as shown in FIG. 2, based on image data of the synthetic moving picture M composed of the plurality of frame images F . . . generated by the image generation unit 6c, the display control unit 3b switches the respective frame images F . . . at the predetermined reproduction frame rate and displays the frame images F . . . on the display screen of the display panel 3a, and thereby plays back and displays the synthetic moving picture M, in which the subject region G of the foreground image P1 moves while changing the display style by taking the shapes of the two operation orbits L and L as references (Step S10).

Thereafter, based on the predetermined operation for the operation input unit 4 by the user, the central control unit 1 determines whether or not an instruction to store the synthetic moving picture M in the image recording unit 7 is inputted (Step S11).

Here, when it is determined that the instruction to store the synthetic moving picture M is inputted (Step S11; YES), the central control unit 1 stores the image data of the synthetic moving picture M, which is composed of the plurality of frame images F . . . , in a predetermined recording region of the image recording unit 7 (Step S12), and ends the synthetic image generation processing.

Meanwhile, in Step S11, when it is determined that the instruction to store the synthetic moving picture M is not inputted (Step S11; NO), the central control unit 1 skips the processing of Step S11, and ends the synthetic image generation processing.

As described above, in accordance with the portable terminal 100 of this embodiment, the display style of the foreground image P1, which is to be moved and displayed along the two operation orbits L and L rendered based on the predetermined operation for the operation input unit 4 by the user and is to be superimposed and displayed on the background image P2, is changed by taking the shapes of the operation orbits L and L concerned as references. Accordingly, the synthetic moving picture M can be generated, in which the foreground image P1 of which display style is changed in response to the change of the shapes of the two operation orbits L and L is superimposed on the background image P2. Hence, in comparison with a device that simply moves and displays the foreground image P1 along the operation orbits L, entertainment characteristics of the synthetic moving picture M can be achieved.

Specifically, the size of the foreground image P1 is changed in response to the interval between the two operation orbits L and L, and accordingly, the synthetic moving picture M can be generated, in which the subject region G of the foreground image P1 is enlarged and reduced in response to the interval between the two operation orbits L and L concerned.

At this time, the size of the subject region G of the foreground image P1 is changed so that the ratio in number of pixels (size) between the horizontal direction (predetermined direction) of the subject region G concerned and the vertical direction (direction perpendicular to the predetermined direction) thereof cannot be changed. In such a way, a feeling of wrongness in the event of enlarging and reducing the subject region C of the foreground image P1 is reduced, and the synthetic moving picture M, which looks more natural, can be generated.

Moreover, the subject region G of the foreground image P1, which is to be moved and displayed along the two operation orbits L and L, is rotated so that the reference line segment, which passes through the predetermined position of the foreground image P1, can be substantially perpendicular to the reference line set between the operation orbits L concerned. In such a way, the change of the display style of the subject region G of the foreground image P1 can be further diversified, and enhancement of the entertainment characteristics of the synthetic moving picture M can be achieved.

Moreover, the display position of the foreground image P1 is moved from the start point side of either one operation orbit L between the two operation orbits L and L to the endpoint side thereof, and accordingly, the movement and display of the subject region G of the foreground image P1, which are along the operation orbits L, can be performed appropriately, whereby the generation of the synthetic moving picture M can be performed appropriately.

Furthermore, in the image synthesis processing for synthesizing the background image P2 and the foreground image P1 with each other, the display style of the foreground image P1 is changed by taking the shapes of the at least two operation orbits L and L as references, and accordingly, only by performing the image synthesis processing, the synthetic moving picture M can be automatically generated, in which the display style of the foreground image P1 is changed in accordance with the change of the shapes of the two operation orbits L and L.

Note that the present invention is not limited to the above-described embodiment, and may be subjected to varieties of improvements and design changes within the scope without departing from the spirit of the present invention.

For example, in the above-described embodiment, the portable terminal 100 is configured to change the display style of the foreground image P1 in the event of synthesizing the foreground image P1 concerned and the background image P2 with each other by the image synthesis unit 6c; however, whether or not to include the image synthesis unit 6c is changeable arbitrarily as appropriate, and any configuration may be adopted as long as the configuration is one to change the display style of the subject region G of the foreground image P1, which is to be superimposed and displayed on the background image P2, in the event of moving and displaying the subject region G concerned along the two operation orbits L and L.

Moreover, in the above-described synthetic image generation processing, the synthetic moving picture M is stored in the image recording unit 7; however, whether or not to store the synthetic moving picture M concerned is changeable arbitrarily as appropriate, and a configuration in which the generated synthetic moving picture M is simply played back and displayed may be adopted.

Moreover, for example, in the case of applying a moving picture, which is composed of the plurality of frame images, as the foreground image P1, a moving speed and reproduction frame rate of the foreground image P1 may be changed, for example, in consideration of the length, thickness and the like of the operation orbits L.

Moreover, the configuration of the portable terminal 100, which is illustrated in the above-described embodiment, is merely an example, and the configuration of the portable terminal 100 according to the present invention is not limited to this. Furthermore, the portable terminal 100 is illustrated as the image processing apparatus; however, the image processing apparatus according to the present invention is not limited to this.

In addition, in the above-described embodiment, a configuration is adopted, in which functions as first obtaining means, specifying means and control means are realized in such a manner that the first image obtaining unit 6a, the orbit specifying unit 5 and the synthesis control unit 6d are driven under the control of the central control unit 1; however, such a configuration to realize these functions is not limited to this, and a configuration may be adopted, in which these means are realized in such a manner that a predetermined program and the like are executed by the CPU of the central control unit 1.

That is to say, in a program memory (not shown) that stores programs therein, a program that includes a first obtaining processing routine, a specifying processing routine, and a control processing routine is stored in advance. Then, by the first obtaining processing routine, the CPU of the central control unit 1 may be allowed to function as obtaining means for obtaining a predetermined image. Moreover, by the specifying processing routine, the CPU of the central control unit 1 may be allowed to function as means for specifying at least two orbits, which are rendered based on a predetermined operation for operation input means by the user, on a display region of display means. Furthermore, by the control processing routine, the CPU of the central control unit 1 may be allowed to function as means for changing a display style of the predetermined image, which is to be moved and displayed along the at least two orbits thus specified and is to be superimposed and displayed on the background image P2 by taking shapes of the orbits concerned as references.

In a similar way, such a configuration may be adopted, in which second obtaining means and synthesis means are also realized in such a manner that a predetermined program and the like are executed by the CPU of the central control unit 1.

Moreover, as computer-readable mediums which store therein the programs for executing the above-described respective pieces of processing, it is also possible to apply a non-volatile memory such as a flash memory, and a portable recording medium such as a CD-ROM as well as a ROM, a hard disk and the like. Moreover, as a medium that provides data of the programs through a predetermined communication line, a carrier wave is also applied.

Some of the embodiments of the present invention have been described; however, the scope of the present invention is not limited to the above-mentioned embodiments, and incorporates the scope of the invention, which is described in the scope of claims, and incorporates equilibrium ranges thereof.

What is claimed is:

1. An image processing apparatus comprising:
a first obtaining unit which obtains a predetermined image;
a specifying unit which specifies at least two orbits on a display region of a display unit, the orbits being rendered based on a predetermined operation for an operation unit by a user; and
a control unit which changes a display style of the predetermined image by taking as references shapes of the at least two orbits specified by the specifying unit, the predetermined image to be moved and displayed along the orbits and to be superimposed and displayed on a background image.

2. The image processing apparatus according to claim 1, wherein the control unit further changes a size of the predetermined image in response to an interval between the at least two orbits.

3. The image processing apparatus according to claim 2, wherein the control unit further changes the size of the predetermined image so as not to change a ratio in size of the predetermined image between a predetermined direction and a direction perpendicular to the predetermined direction.

4. The image processing apparatus according to claim 1, wherein the control unit further rotates the predetermined image, the image to be moved and displayed along the at least two orbits, so that a reference line segment passing through a predetermined position of the predetermined image is substantially perpendicular to a reference line set between the orbits.

5. The image processing apparatus according to claim 1, wherein the control unit further moves a display position of the predetermined image from a start point side of either one orbit between the at least two orbits to an endpoint side of the orbit.

6. The image processing apparatus according to claim 1, further comprising:
a second obtaining unit which obtains the background image; and
a synthesis unit which synthesizes the predetermined image and the background image with each other,
wherein the control unit changes the display style of the predetermined image in an event of synthesizing the predetermined image and the background image with each other by the synthesis unit.

7. The image processing apparatus according to claim 1, wherein the specifying unit further specifies the at least two orbits in a state where the background image is displayed on the display region of the display unit, the orbits being rendered based on the predetermined operation for the operation unit by the user.

8. An image processing method using an image processing apparatus, comprising the steps of:
obtaining a predetermined image;
specifying at least two orbits on a display region of a display unit, the orbits being rendered based on a predetermined operation for an operation unit by a user; and
changing a display style of the predetermined image by taking as references shapes of the at least two specified orbits, the predetermined image to be moved and displayed along the orbits and to be superimposed and displayed on a background image.

9. A computer-readable medium recording a program which makes a computer of an image processing apparatus function as:
a first obtaining unit which obtains a predetermined image;
a specifying unit which specifies at least two orbits on a display region of a display unit, the orbits being rendered based on a predetermined operation for an operation unit by a user; and
a control unit which changes a display style of the predetermined image by taking as references shapes of the at least two orbits specified by the specifying unit, the predetermined image to be moved and displayed along the orbits and to be superimposed and displayed on a background image.
